(19) United States
(12) Patent Application Publication
(10) Pub. No.: US 2007/0195164 A1
(43) Pub. Date: Aug. 23, 2007

(54) ENDOSCOPE PROCESSOR, COMPUTER PROGRAM PRODUCT, AND ENDOSCOPE SYSTEM

(75) Inventor: Mitsufumi FUKUYAMA, Hyogo (JP)

Correspondence Address: GREENBLUM & BERNSTEIN, P.L.C., 1950 ROLAND CLARKE PLACE, RESTON, VA, 20191, US

(73) Assignee: PENTAX CORPORATION, Tokyo (JP)

(21) Appl. No.: 11/676,636

(22) Filed: Feb. 20, 2007

(30) Foreign Application Priority Data
Feb. 20, 2006 (JP) 2006-042222

(51) Int. Cl. H04N 7/18

(52) U.S. Cl. 348/65

(57) ABSTRACT

An endoscope system comprising a signal receiver, a determination block, a correction signal generation block, and a black balance correction block, is provided. The signal receiver receives a pixel signal generated by a pixel. A plurality of the pixel arranged on a light receiving surface on an imaging device. The imaging device is used for capturing an object. The determination block determines whether the pixel signal is a black signal. The black signal is generated by a pixel receiving an optical image of a black area. The correction signal generation block generates a correction signal based on the black pixel signal. The black balance correction block adjusts a black balance of the pixel signal with using the correction signal.

### BACKGROUND OF THE INVENTION

1. Field of the Invention

The present invention relates to the black balance adjustment of an image captured with an electronic endoscope.

2. Description of the Related Art

An electronic endoscope, having an imaging device at the end of an insertion tube, is used for medical examinations, industrial examinations, and so on. For the purpose of an accurate observation, it is desired to have an image displayed on the monitor with the same color as that of the actual optical image captured by the imaging device. Black balance adjustment is carried out so that the color of the displayed image is the same as that of the actual optical image.

For the black balance adjustment in prior art, first, a black image signal corresponding to an optically black image is sampled once before observation by capturing an optical image such as what would be obtained by covering an end of an insertion tube with a cover. Second, the black level of the captured optical image for observation is adjusted with the sampled black image signal.

The signal level of the black image signal in use may change from that of the sampled black image signal by some factors. For example, the factors are a variation in light emitted from a light source per unit time, or a rise in temperature of either the imaging device or an internal circuit. Consequently, the quality of the displayed image may be lowered.

As for this problem, Japanese Patent Publication No. H09-107550 discloses using an electric shutter to sample a black image signal between two field periods used for capturing an actual optical image. However, motion resolution is lowered because a complete optical image is not captured in one field period of two successive field periods.

### SUMMARY OF THE INVENTION

Therefore, an object of the present invention is to provide an endoscope processor that carries out an adequate black balance while preventing the reduction of motion resolution.

According to the present invention, an endoscope processor comprising a receiver, a determination block, a correction signal generation block, and a black balance correction block is provided. The signal receiver receives a pixel signal. The pixel signal is generated by a plurality of pixels. A plurality of pixels arranged on a light receiving surface on an imaging device for capturing an object. The determination block determines whether the pixel signal is a black pixel signal. The black pixel signal is generated by a pixel received from an optical image of a black area in an optical image of the object. The correction signal generation block generates a correction signal based on the black pixel signal. The correction signal is used to adjust the black balance of the pixel signal. The black balance correction block adjusts the black balance of the pixel signal, with use of the correction signal.

Further, the endoscope processor comprises a luminance signal generation block. The luminance signal generation block generates a luminance signal based on the pixel signal. The determination block determines whether the pixel signal is the black pixel signal based on the luminance signal.

Further, the pixel signal comprises red, green, and blue signal components. The correction signal generation block generates red and blue correction signals. The red correction signal is the difference between the red and green signal components of the black pixel signal. The blue correction signal is the difference between the blue and green signal components of the black pixel signal. The black balance correction block adjusts the black balance of the pixel signal by correcting the red and blue signal components based on the red and blue correction signals, respectively.

Further, the endoscope processor comprises a memory block. The memory block stores the correction signal. The black balance correction block adjusts the black balance of the pixel signal based on the correction signal stored in the memory block.

### BRIEF DESCRIPTION OF THE DRAWINGS

The objects and advantages of the present invention will be better understood from the following description, with reference to the accompanying drawings in which:

FIG. 1 is a block diagram showing the internal structure of an endoscope system having an endoscope processor of an embodiment of the present invention;

FIG. 2 is a block diagram showing the structure of the black balance adjustment block of the first embodiment;

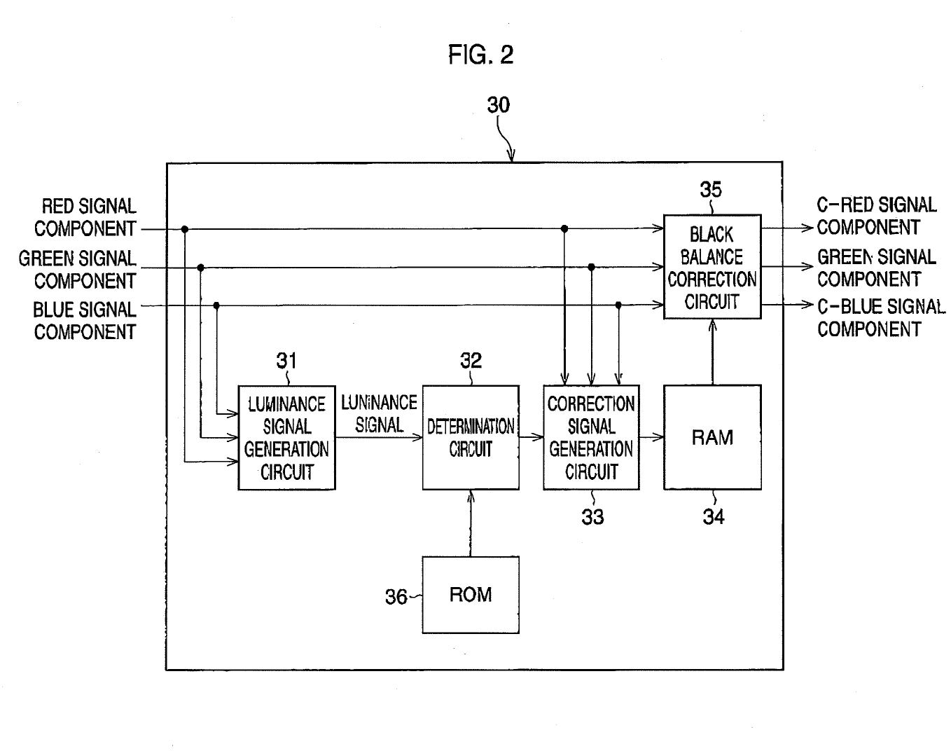

FIG. 3 is a flowchart describing the black balance adjustment process carried out by the black balance adjustment block; and

FIG. 4 is a block diagram showing the structure of the black balance adjustment block of the second embodiment.

### DESCRIPTION OF THE PREFERRED EMBODIMENTS

The present invention is described below with reference to the embodiments shown in the drawings.

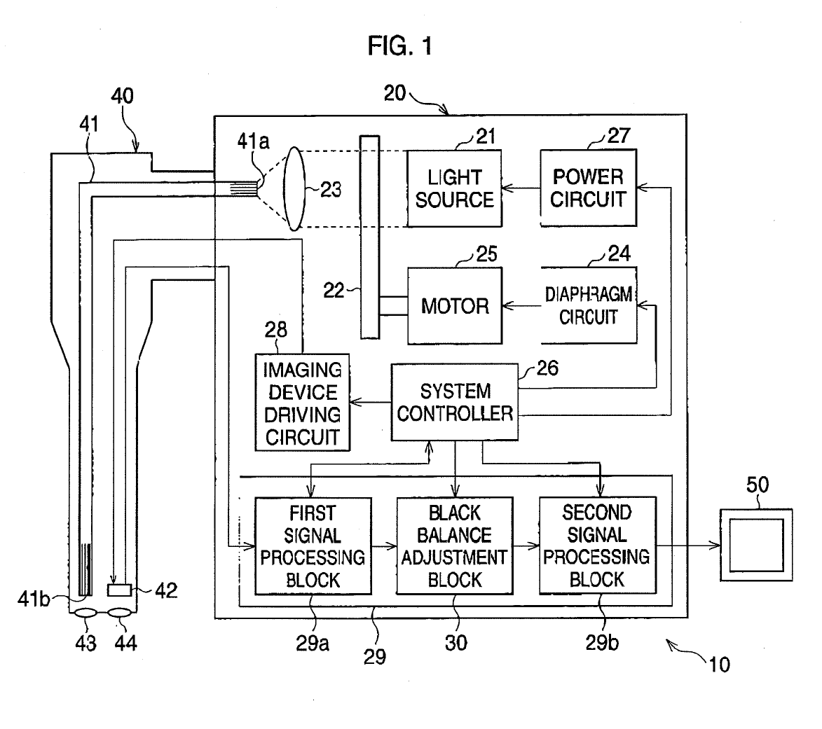

In FIG. 1, an endoscope system 10 of the first embodiment comprises an endoscope processor 20, an electronic endoscope 40, and a monitor 50. The endoscope processor 20 is connected to the electronic endoscope 40 and the monitor 50 via connectors (not depicted).

The whole structure of the endoscope system 10 is briefly explained. A light source 21 is housed in the endoscope processor 20. The light source 21 emits light for illuminating an object (not depicted). The light emitted from the light source 21 is irradiated onto an object (not depicted) via a light guide 41 housed in the electronic endoscope 40.

An imaging device 42, such as a CCD image sensor, is mounted in the electronic endoscope 40. The optical image of the irradiated object is captured by the imaging device 42. Then, the imaging device 42 generates an image signal corresponding to the captured optical image. The image signal is sent to the endoscope processor 20. For the image signal, predetermined signal processing is carried out by the endoscope processor 20. The image signal, having undergone the predetermined signal processing, is then sent to the monitor 50, where the image is displayed.

Next, each component is explained in detail, as follows. A diaphragm 22 and the condenser lens 23 are mounted in the optical path from the light source 21 to the incident end 41a of the light guide 41. The light, which is composed almost entirely of parallel light beams emitted by the light source 21, is made incident on the incident end 41a, through the condenser lens 23. The condenser lens 23 condenses the light for the incident end 41a.

The intensity of the light, made incident on the incident end 41a, is adjusted by driving the diaphragm 22. The diaphragm 22 is driven by a motor 25. Movement of the motor 25 is controlled by the diaphragm circuit 24. The diaphragm circuit 24 is connected to a first signal processing block 29a via a system controller 26. The first signal processing block 29a detects the magnitude of light received for a captured optical image based on an image signal generated by the imaging device 42. The diaphragm circuit 24 calculates a driving quantity for the motor 25 based on the magnitude of light received.

A power circuit 27, which supplies power to the light source 21, is Electrically connected to the system controller 26. A control signal for switching the light source 21 on and off is output from the system controller 26 to the power circuit 27. Accordingly, lighting (on and off) of the light source 21 is controlled by the system controller 26.

Further, the system controller 26 outputs a driving signal necessary for driving the imaging device 42, to an imaging device driving circuit 28. The imaging device 42, which is driven by the imaging device driving circuit 28, generates an image signal corresponding to a captured image.

Further, the system controller 26 controls movement of the whole endoscope processor 20. A video signal processing block 29 is controlled by the system controller 26, as described later.

The light made incident on the incident end 41a is transmitted to an exit end 41b via the light guide 41. The transmitted light illuminates a peripheral area near the head end of an insertion tube of the electronic endoscope 40 after passing through a diffuser lens 43. An optical image of the illuminated object is captured by the imaging device 42 through an object lens 44.

A frame or field of an image signal, based on an optical image captured by the imaging device 42, is generated by the imaging device 42. The image signal is sent to the video signal processing block 29 housed in the endoscope processor 20.

A plurality of pixels (not depicted) is arranged in two dimensions on a light receiving surface on the imaging device 42. Each pixel is covered with one color filter among red, green, and blue color filters. Red, green, and blue light components pass through the red, green, and blue color filters, respectively. A light component that passes through a color filter is made incident on the pixel that is covered by the color filter.

Each pixel generates a pixel signal in accordance with the magnitude of the received light component. The image signal of one frame or one field comprises a plurality of pixel signals generated by a plurality of the pixels forming an entire image of one frame or one field.

The video signal processing block comprises a first signal processing block 29a, a black balance adjustment block 30, and a second signal processing block 29b.

The image signal generated by the imaging device 42 is sent to the first signal processing block 29a. The first signal processing block 29a carries out predetermined signal processing, which includes color separation processing followed by color interpolation processing of the image signal.

In the color separation processing, the image signal is separated into red, green, and blue signal components, which are pixel signals categorized in accordance with their specific magnitude of red, green, and blue light components, respectively. In this moment, one pixel signal consists of only one color signal component among the red, green, and blue signal components because each pixel can directly generate only one color signal component corresponding to its covered color filter.

During the color interpolation processing, in addition to the generated color signal component, two additional color signal components inherent within each pixel signal prior to the color interpolation processing, are synthesized. For example, in a pixel signal that a pixel covered with the green color filter generated and consists of a green color signal component, the red and blue color signal components would be synthesized. Each pixel signal then consists of all of three color signal components.

Further, the image signal, which is an analog signal, is converted to image data, which is digital data. The image data is sent to the black balance adjustment block 30.

The black balance adjustment block 30 carries out the black balance adjustment for the image data. The structure and operation of the black balance adjustment block 30 is explained in detail below.

The black balance adjustment block 30 comprises a luminance signal generation circuit 31, a determination circuit 32, a correction signal generation circuit 33, a RAM 34, black balance correction circuit 35, and ROM 36.

The black balance adjustment is carried out for all pixel signals by the black balance correction circuit 35. A correct signal is used for the black balance adjustment. The correct signal is generated by the correct signal generation circuit 33. The pixel signal used for generation of the correct signal is selected by the determination circuit 32.

Further, more detailed explanation is described below. The red, green, and blue signal components of each pixel signal are input to the black balance adjustment block 30 in parallel. The red, green, and blue signal components are input to the luminance signal generation circuit 31, the correction signal generation circuit 33, and the black balance correction circuit 35.

The luminance signal generation circuit 31 generates a luminance signal, which is in accordance with luminance of light received from each pixel, based on the red, green, and blue signal components. The generated luminance signal is then sent to the determination circuit 32.

The determination circuit 32 compares the signal level of the received luminance signal to a predetermined threshold stored in the ROM 36 to determine if the received luminance signal corresponds to black or not. When the signal level or the luminance signal Is below the predetermined threshold, the determination circuit 32 determines that a pixel corresponding to the received pixel signal is a black pixel with a standard black luminance level.

When the determination circuit 32 determines that the pixel corresponding to the received pixel is a black pixel, the correction signal generation circuit 33 generates a correction signal. On the other hand, when the pixel corresponding to the sent pixel is not determined to be a black pixel, the correction signal is not generated.

The correction signal generation circuit 33 generates both a red and blue correction signal based on the red, green, and blue signal components of the pixel signal sent to the correction signal generation circuit 33. The red correction signal is a signal of which the signal level is the difference of signal levels between the red and green signal components. The blue correction signal is a signal of which the signal level is the difference of signal levels between the blue and green signal components.

The generated red and blue correction signals are sent to and stored in the RAM 34. Previously received red and blue correction signals stored in the RAM 34 are updated with newly received red and blue correction signals.

The black balance correction circuit 35 receives the red and the blue correction signals from the RAM 34 and, as described above, the black balance correction circuit 35 receives the red, green, and blue signal components corresponding to each pixel.

The black balance correction circuit 35 generates a corrected red signal component, hereinafter referred to as c-red signal component, and a corrected blue signal component, hereinafter referred to as c-blue signal component. The c-red signal component is a signal component of which signal level is the difference between the signal levels of the red signal component and the red correction signal. The c-blue signal component is a signal component of which signal level is the difference between the signal levels of the blue signal component and the blue correction signal.

The red and the blue signal components sent to the black balance correction circuit 35 are replaced with the c-red and c-blue signal components, respectively. The c-red signal component, c-blue signal component, and green signal component that are sent to the black balance correction circuit 35 are all output as a pixel signal, having undergone the black balance adjustment.

The pixel signal, having undergone the black balance adjustment, is sent to the second signal processing block 29b (see FIG. 1). The second signal processing block 29b carries out predetermined signal processing, such as contrast adjustment processing and enhancement processing, for an image data comprising one frame or one field of pixel signals sent to the second signal processing block 29b. In addition, D/A conversion processing is carried out for the image data, which is then converted to an analog image signal. Further, a composite video signal including the image signal and a synchronizing signal is generated.

The composite video signal is sent to the monitor 50. Then an image based on the composite video signal is displayed on the monitor 50.

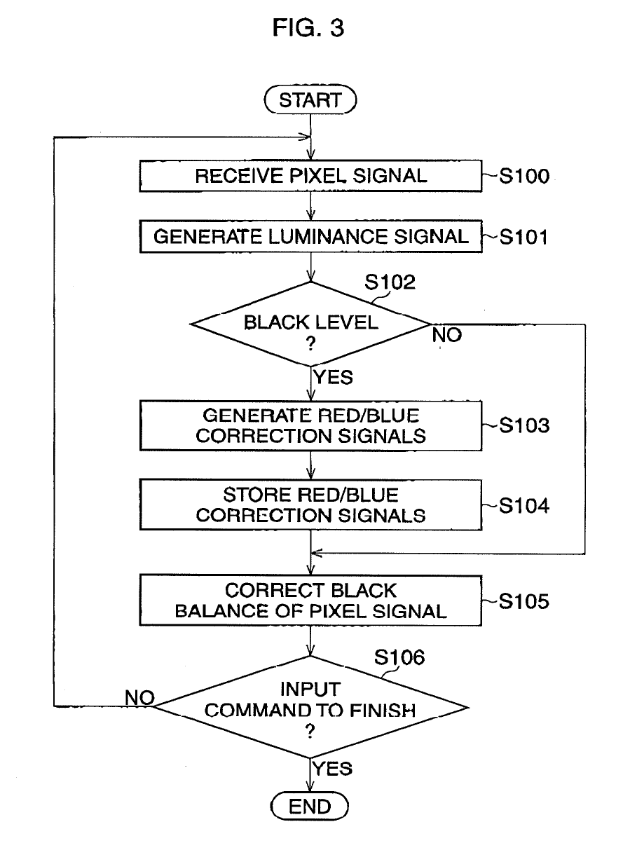

Next, black balance adjustment processing is carried out by the black balance adjustment block 30, as explained below using the flowchart in FIG. 3.

Black balance adjustment processing starts when the endoscope processor 20 is connected to both the electronic endoscope 40 and the monitor 50 and power is supplied to the endoscope processor 20.

At step S100, the black balance adjustment block 30 receives the pixel signal, comprising the red, green, and blue signal components, from the first signal processing circuit 29a. Then at step S101, the luminance signal is generated based on the received pixel signal.

After generating the luminance signal, the process proceeds to step S102. At step S102, it is determined whether or not the signal level of the generated luminance signal is lower than the predetermined threshold. In other words, it is determined whether the signal level of the luminance signal is substantially the black level or not.

When the signal level of the luminance signal is substantially the black level, the process proceeds to step S103. At step S103, the red and the blue correction signals are generated based on the pixel signal received at step S100. The generated red and blue correction signals are stored in the RAM 34 at step S104. Incidentally, if the RAM 34 has stored the previous red and blue correction signals, the stored red and the blue correction signals are updated with the most recently received red and blue correction signals, respectively.

After storing the red and blue correction signals, the process proceeds to step S105. However, when the signal level of the luminance signal is not substantially the black level at step S102, the process skips steps S103 and S104, and proceeds directly to step S105.

At step S105, the black balance of the pixel signal received at step S100 is corrected based on the red and the blue correction signals stored in the RAM 34. The pixel signal, having undergone the black balance correction, is then sent to the second signal processing block 29b.

At step S106, it is determined whether there is an input command to finish the observation by the endoscope processor 20. If there is an input command to finish, then the black balance adjustment processing finishes; otherwise, the process returns to step S100. The processes from step S100 to step S106 are repeated until there is an input command to finish.

In the above first embodiment, the red and blue correction signals for the black balance adjustment can be updated and an adequate black balance adjustment can be carried out with the updated correction signals when there is an optically black area in the optical image captured by the electronic endoscope 40. An electronic endoscope is often used for observing an internal tissue of a human's body or an internal structure of a machine. There is a lot of optically black area in the optical image of such objects. Accordingly, the update of the red and the blue correction signals are often carried out, and an adequate black balance adjustment is carried out using the endoscope system 10 without lowering the motion resolution.

The second embodiment is explained below. The second embodiment is different from the first embodiment, mainly regarding the structure and operations of the black balance adjustment block. Therefore, the second embodiment is explained mainly with regard to the structures of the second embodiment that are different from those of the first embodiment. The same symbols are used for the structures that are the same as those in the first embodiment.

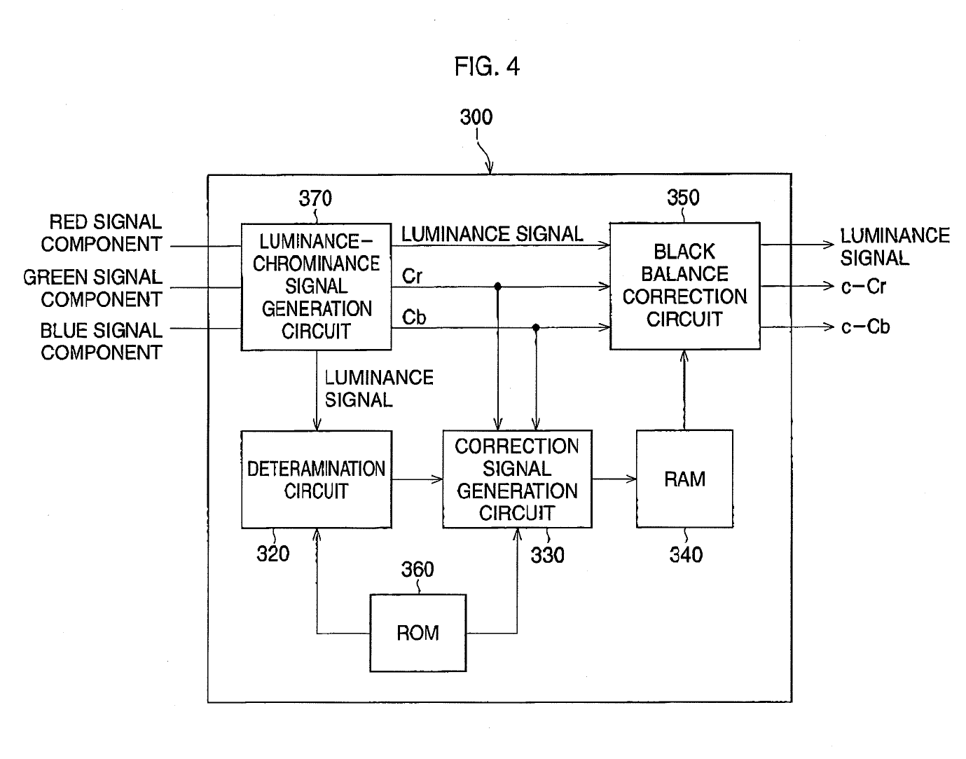

As shown in FIG. 4, the black balance adjustment block 300 comprises a luminance-chrominance signal generation circuit 370, a determination circuit 320, a correction signal generation circuit 330, a RAM 340, and a black balance correction circuit 350.

The red, green, and blue signal components of each pixel signal are input to the black balance adjustment block 300 in parallel, like the first embodiment. The red, green, and blue signal components received by the black adjustment block 300 are output to the luminance-chrominance signal generation circuit 370.

The luminance-chrominance signal generation circuit 370 generates both luminance and chrominance signals corresponding to each pixel based on the red, green and blue signal components. The chrominance signal is hereinafter referred to as Cr and Cb. The luminance signal is sent to the determination circuit 320 and the black balance correction circuit 350. Cr and Cb are sent to the correction circuit 330 and the black balance correction circuit 350.

The determination circuit 320 compares the signal level of the received luminance signal to a predetermined threshold. The determination circuit 320 determines if the signal level of the received luminance signal is of a substantial black level, where luminance corresponds to black or not, in a manner similar to the first embodiment. When the signal level of the luminance signal is lower than the predetermined threshold, the determination circuit 320 determines that a pixel corresponding to a sent pixel signal is the black pixel of which luminance is regarded as a standard black level. Incidentally, the predetermined threshold is stored in the ROM 360, in a manner similar to the first embodiment.

When the determination circuit 320 determines that the pixel corresponding to the received pixel is the black pixel, the correction signal generation circuit 330 generates Cr and Cb correction signals based on Cr and Cb, respectively, which were included in the pixel signal sent to the correction signal generation circuit 330.

The ideal signal levels of Cr and Cb corresponding to optical black can be assumed. The assumed Cr and Cb, corresponding to optical black, are defined as Cr and Cb blacks, respectively. The Cr and Cb blacks are stored in the ROM 360 and read by the correction signal generation circuit, as required The Cr correction signal is a signal of which the signal level is the difference of signal levels between Cr and Cr black. The Cb correction signal is a signal of which the signal level is the difference of signal levels between Cb and Cb black.

The generated Cr and Cb correction signals are sent to and stored in the RAM 340. When previously sent Cr and Cb correction signals have been stored in the RAM 340, these stored signals are updated with the newly received Cr and Cb correction signals.

The black balance correction circuit 350 receives the Cr and the Cb correction signals from the RAM 340, and as described above, the black balance correction circuit 350 receives the luminance signal, Cr and Cb, corresponding to each pixel.

The black balance correction circuit 350 generates corrected Cr, hereinafter referred to as c-Cr, and corrected Cb, hereinafter referred to as c-Cb. The c-Cr is a signal component of which signal level is the difference between signal levels of Cr and the Cr correction signal. The c-Cb is a signal component of which signal level is the difference between signal levels of Cb and the Cb correction signal.

The Cr and Cb sent to the black balance correction circuit 350 are replaced by the a-Cr and c-Cb, respectively The c-Cr, c-Cb, and the luminance signal which is sent to the black balance correction circuit 350 are output as a pixel signal, having undergone the black balance adjustment. The pixel signal output from the black balance correction circuit 350 comprises the luminance signal, c-Cr, and c-Cb. The pixel signal is then sent to the second signal processing block 29b.

In the above second embodiment, the Cr and Cb correction signals for the black balance adjustment can be updated and an adequate black balance adjustment can be carried out with the updated correction signals, as in the first embodiment.

The correction signals generated from the pixel signal corresponding to a single black pixel are stored in the RAM 34, 340, and the stored correction signals are updated when newly generated correction signals are input to the RAM 34, 340 in both the first and second embodiments. However, the correction signals generated from a plurality of pixel signals corresponding to multiple black pixels may also be stored in the RAM 34, 340.

It is preferable to use the latest correction signal for an adequate black balance adjustment corresponding to the continually changing black level. However, noise may be mixed into a pixel signal, and a correction signal generated from a pixel signal mixed with noise may influence the black balance adjustment. In regard to this problem, the correction signal may be generated by an average signal of a plurality of the pixel signals stored in the RAM 34, 340. The effect of noise can be lowered by using such a correction signal.

The above embodiment can be implemented by installing a program for black balance adjustment onto an all-purpose endoscope processor. The program for black balance adjustment comprises a controller code segment, a determination block code segment, correction signal generation code segment, and a black balance correction block code segment.

Although the embodiments of the present invention have been described herein with reference to the accompanying drawings, obviously many modifications and changes may be made by those skilled in this art without departing from the scope of the invention.

The present disclosure relates to subject matter contained in Japanese Patent Application No. 2006-042222 (filed on Feb. 20, 2006), which is expressly incorporated herein, by reference, in its entirety.

1. An endoscope processor, comprising;
a signal receiver that receives a pixel signal generated by a plurality of pixels arranged on a light receiving surface on an imaging device for capturing an object;
a determination block that determines whether said pixel signal is a black pixel signal generated by a pixel received from an optical image of a black area in an optical image of said object;
a correction signal generation block that generates a correction signal, which is used to adjust the black balance of said pixel signal, based on said black pixel signal; and
a black balance correction block that adjusts the black balance of said pixel signal with use of said correction signal.

2. An endoscope processor according to claim 1, further comprising a luminance signal generation block that generates a luminance signal based on said pixel signal; and said determination block determines whether said pixel signal is said black pixel signal based on said luminance signal.

3. An endoscope processor according to claim 1, further comprising a chrominance signal generation block that generates a chrominance signal based on said pixel signal; and
said correction signal generation block generates said correction signal based on said chrominance signal generated based on said black pixel signal and a predetermined chrominance signal, said predetermined chrominance signal being assumed to be said Ideal chrominance signal corresponding to said black pixel, and
said black balance correction block adjusts the black balance of said pixel signal by correcting said chrominance signal with said correction signal.

4. An endoscope processor according to claim 1, wherein,
said pixel signal comprises red, green, and blue signal components,
said correction signal generation block generates red and blue correction signals as said correction signal, said red correction signal being the difference between said red and said green signal component of said black pixel signal, said blue correction signal being the difference between said blue and green signal components of said black pixel signal, and
said black balance correction block adjusts the black balance of said pixel signal by correcting said red and said blue signal components based on said red and said blue correction signals, respectively.

5. An endoscope processor according to claim 1, further comprising a memory block that stores said correction signal generated by said correction signal generation block, and said black balance correction block adjusts the black balance of said pixel signal based on said correction signal stored in said memory block.

6. An endoscope processor according to claim 5, wherein,
when said pixel signal received by said signal receiver is determined to be said block pixel signal, said correction signal generation block generates said correction signal based on said black pixel signal newly received by said signal receiver, and
when said correction signal generation block newly generates said correction signal, said memory block updates said stored correction signal with said newly generated correction signal.

7. An endoscope processor according to claim 5, wherein said memory block stores a plurality of said correction signals generated from a plurality or said black pixel signals, said black balance correction block adjusts the black balance of said pixel signal based on an averaged-signal which is generated by averaging said black pixel signals stored in said memory block.

8. A computer program product, comprising:
a controller that activates a signal receiver so that said signal receiver receives a pixel signal generated by a plurality of pixels arranged on a light receiving surface on an imaging device for capturing an object;
a determination block that determines whether said pixel signal is a black pixel signal that is generated by a pixel receiving an optical image of a black area in an optical image of said object;
a correction signal generation block that generates a correction signal used to adjust the black balance of said pixel signal based on said correction signal; and
a black balance correction block that adjusts the black balance of said pixel signal with use of said correction signal.

9. An endoscope system, comprising:
An electronic endoscope having an imaging device that generates a pixel signal from a plurality of pixels arranged on a light receiving surface on said imaging device;
a determination block that determines whether said pixel signal is a black pixel signal generated by a pixel receiving an optical image of a black area in an optical image of said object;
a correction signal generation block that generates a correction signal used to adjust the black balance of said pixel signal based on said correction signal; and
a black balance correction block that adjusts the black balance of said pixel signal with use of said correction signal.
